(19) United States
(12) Patent Application Publication
(10) Pub. No.: US 2002/0125806 A1
(43) Pub. Date: Sep. 12, 2002

(54) Cathode for cathode-ray tube having high current density and long life

(75) Inventors: Toshikazu Sugimura, Ohtsu-shi (JP); Yoshiyuki Tanaka, Ohtsu-shi (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/086,870

(22) Filed: Mar. 4, 2002

(30) Foreign Application Priority Data
Mar. 6, 2001 (JP) 2001-061015
Apr. 26, 2001 (JP) 2001-128961

(51) Int. Cl. H01J 1/14

(52) U.S. Cl. 313/346 R

(57) ABSTRACT

A cathode for a cathode-ray tube which has high current density and long life and which can be mass-produced without dispersion of a cathode pellet temperature. The cathode comprises a cathode pellet formed from a sintered body which is obtained by sintering a mixture containing at least a nickel powder and a powder of electron emission agent by hot isostatic pressing. The cathode also comprises a cathode pellet support member on which the cathode pellet is attached. According to the present invention, the cathode pellet support member is a bottom plate which covers only a bottom surface of the cathode pellet. The cathode pellet may have a column shape, and the bottom plate may have a disk shape or a reversed cup shape.

### FIELD OF THE INVENTION

The present invention relates generally to a cathode for a cathode-ray tube, a cathode-ray tube, and a method of manufacturing them. More particularly, the present invention relates to a cathode for a cathode-ray tube, for example, a color cathode-ray tube which has high current density and long life and which can be mass-produced without dispersion of a cathode pellet temperature.

### BACKGROUND OF THE INVENTION

In Japanese patent laid-open publication No. 2001-006521, the inventor of the present invention proposed a new structure of a cathode which obviates a problem of rapid reduction of electron emission at high current density. FIG. 12 is a partially cut away perspective view illustrating such cathode as a conventional cathode 120. An explanation will be made on the conventional cathode 120 and a manufacturing method thereof.

First, nickel powder, scandium oxide powder and electron emission agent are mixed and sintered by a hot isostatic pressing process to make a sintered body. Next, a cathode pellet 121 is cut out from the sintered body. The cathode pellet 121 has a column shape member which is 1.1 mm in diameter and 0.22 mm in thickness. The cathode pellet 121 is then housed into a cup 122 which has an inner diameter of 1.1 mm, a depth of 0.2 mm and a board thickness of 50 μm, and the cathode pellet 121 and the cup 122 are welded.

The above-mentioned process is explained in detail. First, the cathode pellet 121 is inserted into the cup 122. The cup 122 into which the pellet 121 is inserted is then inserted into the top portion of a sleeve 123, and the peripheral portion of the top portion of the sleeve 123 is resistance welded. Also, if there is a gap between the bottom surface of the cathode pellet 121 and the cup 122, heat conduction is deteriorated. Therefore, when the cathode pellet 121 is inserted into the cup 122, the cathode pellet 121 is strongly pressed down into the cup 122 such that no gap exists between the cathode pellet 121 and the cup 122. Also, the cup 122 and the cathode pellet 121 is laser welded from the back surface of the cup 122 to avoid the rise of the cathode pellet 121 from the inner bottom surface of the cup 122.

The cup 122 is made of an alloy of nickel and chromium which contains 80 percent nickel and 20 percent chromium. The reason why the cup 122 is made of nickel-chromium alloy is as follows. That is, in order to emit electrons, it is necessary to reduce barium oxide (BaO) by any reducing agent to produce barium (Ba) metal. In the cathode 120, chromium thermally diffuses into the cathode pellet 121 from the cup 122 which is heated by a heater 124. Thereby, BaO in the electron emission agent is reduced, and Ba metal is produced. Electrons are emitted from the Ba metal produced in this way. In this case, Ba₃(Cr₄)₂ is produced as by-product. However, Ba₃(Cr₄)₂ has a relatively low electric resistance and does not disturb electron emission.

In the above-mentioned cathode 120, electron emission does not deteriorate for 20000 hours or more, even if it is operated at a high current density exceeding 3 A/cm² and an operating temperature is 780 degrees Celsius. Therefore, the conventional cathode 120 already has performance sufficient for practical use. However, it is preferable that the performance of the conventional cathode 120 is further raised and that productivity and usability of the conventional cathode 120 are further improved.

One of the reasons why in the conventional cathode 120 the cathode pellet 121 is covered by the cup 122 is that, as mentioned above, it is necessary to supply reducing agent from the cup 122 to the cathode pellet 121 to reduce BaO for electron emission. However, there is one more important reason. That is, the reason is because it is necessary to prevent electrons from being emitted into the side of the heater 124. If electrons are emitted to the side of the heater 124, the isolation of the heater 124 is deteriorated. The cup 122 prevents electrons from being emitted into the heater 124 to avoid deterioration of isolation of the heater 124.

As mentioned above, the cup 122 of the conventional cathode 120 has an inner diameter of 1.1 mm, a depth of 0.2 mm, and a thickness of board material is 50 μm. Here, the depth of the cup 122 becomes an issue. The depth of the cup 122 having a small depth such as 0.2 mm often varies or disperses when such cup is mass-produced. In order to realize high precision in the depth of the cup even when it is mass-produced, it is required that the depth is 0.3 mm or more. Since the thickness of the cathode pellet 121 should be equal to or larger than the depth of the cup 122, if the depth of the cup 122 is 0.3 mm, the thickness of the cathode pellet 121 becomes 0.3 mm or larger. When the thickness of the cathode pellet 121 is 0.3 mm or larger, heat capacity of the cathode pellet 121 becomes large. Also, in this case, the temperature difference between the bottom surface of the cathode pellet 121 and the electron emitting surface thereof becomes large, and, therefore, the temperature of the heater 124 must be high. However, when the temperature of the heater 124 is high, there is a possibility that the sleeve 123 deforms, isolation of the heater 124 deteriorates, and the like. Therefore, it is not preferable that the depth of the cup 122 is 0.3 mm or more.

A Also, in the conventional cathode 120, when the cathode pellet 121 is inserted into the cup 122, the cathode pellet 121 is strongly pressed into the cup 122, and further the cup 122 and the cathode pellet 121 is laser welded from the bottom surface of the cup 122 such that no gap is produced between the cathode pellet 121 and the cup 122. Laser welding can be done in a noncontact way and causes no contamination to the members to be welded. However, it is difficult to weld the whole bottom surface of the cup 122 with the cathode pellet 121. Therefore, in practice, several points on the bottom surface are welded. However, each portion of the cup 122 on which a laser beam is irradiated is likely to become thicker than other portions, when the portion is melted and set again. To this end, although no gap exists between the cathode pellet 121 and the cup 122 before laser welding, there is a possibility that a gap is produced due to the laser welding. If such gap is produced, the temperature of the cathode pellet 121 varies, even if the temperature of the heater 124 is the same. It may be possible to irradiate the whole bottom surface of the cup 122 by defocusing the laser beam. However, in such method, there is a possibility that the temperature of the whole cathode pellet 121 rises and the electron emission agent decomposes. Therefore, such method is not applicable.

### SUMMARY OF THE INVENTION

Therefore, it is an object of the present invention to provide a cathode for a cathode-ray tube which cathode has a high current density and a long life and which can be mass-produced.

It is another object of the present invention to provide a cathode for a cathode-ray tube which cathode can be mass-produced without causing temperature dispersion of a cathode pellet.

It is still another object of the present invention to provide a cathode for a cathode-ray tube which cathode has a high current density and a fast startup time.

It is still another object of the present invention to provide a cathode-ray tube, for example, a color cathode-ray tube which has a high brilliance and a long life and which has small dispersion of characteristics.

It is still another object of the present invention to obviate the disadvantages of the conventional cathode for a cathode-ray tube and of the conventional cathode-ray tube.

In the cathode according to the present invention, a support member for a cathode pellet is changed from the conventional cup shaped member to a disk shaped member having the same diameter as that of the cathode pellet, or to a reversed cup shaped member. The disk shaped member or the reversed cup shaped member is used as a bottom plate on which the cathode pellet is whole surface welded. The bottom plate shields the heater from electron emission from the cathode pellet. Since the bottom plate can be a simple disk shaped member, or a reversed cup shaped member in which a high precision of the depth is not required, it is possible to easily mass-produce such bottom plate. Also, since the thickness of the cathode pellet is not restrained by the size of the bottom plate, it is possible to determine the thickness of the cathode pellet taking other characteristics preferentially into consideration and freely from the size of the bottom plate. That is, it is possible to reduce the thickness of the cathode pellet, for example, to 0.15 mm or so. Thereby, the heat capacity of the cathode pellet can be reduced, and a startup time of an image screen can be shortened. Also, it is possible to lower the heater temperature.

When compared with the conventional cathode, it is possible to increase the radius of the cathode pellet by the thickness of the cup, for example, by 0.05 mm. Therefore, even if the thickness of the cathode pellet is decreased, it is possible to realize the cathode pellet which has approximately the same amount of electron emission agent as that of the conventional cathode pellet.

The cathode pellet and the bottom plate are put between upper and lower welding electrodes which have approximately the same diameter as that of the cathode pellet, and the cathode pellet and the bottom plate are resistance welded. Thereby, it becomes possible to whole surface weld the cathode pellet and the bottom plate without causing any gap therebetween. Since there is no gap between the cathode pellet and the bottom plate, the temperature of the cathode pellet does not disperse or vary. When welding the cathode pellet and the bottom plate, if a welding current flows through a portion of the cathode pellet from which electrons are actually emitted, that is, if a welding current flows through a central portion of the electron emitting surface which corresponds to a hole of the first grid electrode of a cathode-ray tube, there is a possibility that electron emission characteristics of the cathode pellet deteriorate. Therefore, a portion of the upper welding electrode corresponding to the central portion of the electron emitting surface of the cathode pellet is removed or caved.

In case the bottom plate comprises a reversed cup shaped member, a united member of the cathode pellet and the reversed cup shaped member is inserted into the top portion of a sleeve, and the united member and the top peripheral portion of the sleeve are welded. In this case, since the width of the portion which is usable for welding can be large, it is possible to easily weld the sleeve and the united member.

As a manufacturing method suitable for mass production, the inventor proposes a method in which a cathode wafer and a bottom plate member are whole surface welded to prepare a welded workpiece or a cathode wafer assembly. The welded workpiece is then stamped out or blanked out to obtain cathode pellets with bottom plates. This method is much efficient than a method in which a cathode pellet and a bottom plate is aligned and welded one at a time.

It is suitable that the bottom plate is made, for example, of any of nickel-chromium alloy, nickel-magnesium-chromium alloy, nickel-magnesium-silicon-chromium alloy, nickel-magnesium-tungsten alloy, or nickel-magnesium-silicon-tungsten alloy.

When the bottom plate is made of nickel-chromium alloy, the chromium becomes a reducing agent. In this case, since by-product Ba₃(Cr)₂ has a low electrical resistance, it does not obstruct or disturb electron emission. When the bottom plate is made of any of nickel-magnesium-chromium alloy, nickel-magnesium-silicon-chromium alloy, nickel-magnesium-tungsten alloy, or nickel-magnesium-silicon-tungsten alloy, the magnesium, silicon, chromium or tungsten becomes a reducing agent. In such case, since the reducing function is strong, it is possible to reduce an operating temperature of the cathode pellet. Also, thermal conductivity of the nickel-chromium alloy is relatively low and is approximately 17 W/m*K. On the other hand, thermal conductivity of each of nickel-magnesium-chromium alloy, nickel-magnesium-silicon-chromium alloy, nickel-magnesium-tungsten alloy, and nickel-magnesium-silicon-tungsten alloy is relatively high and is approximately 67 W/m*K, so that the heater temperature can be lowered.

By using the above-mentioned cathode according to the present invention, it is possible to realize a, cathode-ray tube, such as a color cathode-ray tube, which has a high brilliance and a long life and which has small dispersion of characteristics such as a temperature of a cathode pellet.

According to an aspect of the present invention, there is provided a cathode for a cathode-ray tube, the cathode comprising: a cathode pellet formed from a sintered body which is obtained by sintering a mixture containing at least a nickel powder and a powder of electron emission agent by hot isostatic pressing; and a cathode pellet support member on which the cathode pellet is attached to form a cathode pellet assembly, wherein the cathode pellet support member is a bottom plate which covers only a bottom surface of the cathode pellet.

In this case, it is preferable that the bottom plate is made of a material selected from a group consisting of nickel-chromium alloy, nickel-magnesium-chromium alloy, nickel-magnesium-silicon-chromium alloy, nickel-magnesium-tungsten alloy, and nickel-magnesium-silicon-tungsten alloy.

It is also preferable that the thickness of the bottom plate is in a range from 20 to 250 μm.

It is further preferable that the cathode pellet has a column shape, and the bottom plate has a disk shape which has the same diameter as that of the bottom surface of the cathode pellet.

It is advantageous that the cathode pellet has a column shape, and the bottom plate has a reversed cup shape, wherein the cathode pellet is attached to the reversed outside bottom surface of the bottom plate, and the reversed cup shaped bottom plate has the same outer diameter as that of the bottom surface of the cathode pellet.

It is also advantageous that the cathode for a cathode-ray tube further comprises a sleeve, wherein the cathode pellet assembly is attached to the top portion of the sleeve by welding.

It is further advantageous that the cathode for a cathode-ray tube further comprises a heater which is inserted into the sleeve from the bottom portion thereof and which heats the cathode pellet via the bottom plate.

According to another aspect of the present invention, there is provided a cathode-ray tube which includes the cathode as set forth above.

According to still another aspect of the present invention, there is provided a method of manufacturing a cathode for a cathode-ray tube comprising: forming a sintered body by sintering a mixture containing at least a nickel powder and a powder of electron emission agent by hot isostatic pressing; forming a cathode pellet from the sintered body; welding a bottom plate onto the bottom surface of the cathode pellet to form a cathode pellet assembly, wherein the bottom plate covers only a bottom surface of the cathode pellet; inserting the cathode pellet assembly into the top portion of a sleeve and welding the cathode pellet assembly to the sleeve at the top peripheral portion of the sleeve; and inserting a heater into the sleeve from the bottom portion thereof.

In this case, it is preferable that, in the welding a bottom plate onto the bottom surface of the cathode pellet to form a cathode pellet assembly, the cathode pellet and the bottom plate are put between an upper welding electrode and a lower welding electrode which have approximately the same diameter as that of the cathode pellet, thereby resistance welding the cathode pellet and the bottom plate.

It is also preferable that the upper welding electrode has a concave portion at a portion of the bottom surface thereof corresponding to the central portion of the electron emitting surface of the cathode pellet which corresponds to a hole of the first grid electrode of a cathode-ray tube, thereby preventing the central portion of the lower surface of the upper welding electrode from contacting with the central portion of the electron emitting surface.

It is further preferable that the upper welding electrode has an insulating member buried in a portion of the bottom surface thereof corresponding to the central portion of the electron emitting surface of the cathode pellet which corresponds to a hole of the first grid electrode of a cathode-ray tube, thereby preventing a welding current from flowing through the central portion of the electron emitting surface while exerting uniform pressure onto whole surface of the cathode pellet.

According to still another aspect of the present invention, there is provided a method of manufacturing a cathode-ray tube which includes a method of manufacturing a cathode for a cathode-ray tube as set forth above.

According to still another aspect of the present invention, there is provided a method of manufacturing a cathode for a cathode-ray tube comprising: forming a sintered body by sintering a mixture containing at least a nickel powder and a powder of electron emission agent by hot isostatic pressing; forming a cathode wafer from the sintered body; welding a bottom plate member onto the bottom surface of the cathode wafer to form a cathode wafer assembly; working the cathode wafer assembly to form a cathode pellet with a bottom plate, that is, a cathode pellet assembly, wherein the bottom plate covers only a bottom surface of the cathode pellet; inserting the cathode pellet assembly into the top portion of a sleeve and welding the cathode pellet assembly to the sleeve at the top peripheral portion of the sleeve; and inserting a heater into the sleeve from the bottom portion thereof.

In this case, it is preferable that, in the welding a bottom plate member onto the bottom surface of the cathode wafer to form a cathode wafer assembly, the cathode wafer and the bottom plate member are put between an upper welding electrode and a lower welding electrode which have approximately the same diameter as that of the cathode wafer, thereby resistance welding the cathode wafer and the bottom plate member.

It is also preferable that the upper welding electrode has concave portions at portions of the bottom surface thereof each corresponding to the central portion of the electron emitting surface of the cathode pellet which corresponds to a hole of the first grid electrode of a cathode-ray tube, thereby preventing the lower surface of the upper welding electrode from contacting with the central portion of each electron emitting surface.

It is further preferable that the upper welding electrode has insulating members buried in portions of the bottom surface thereof each corresponding to the central portion of the electron emitting surface of the cathode pellet which corresponds to a hole of the first grid electrode of a cathode-ray tube, thereby preventing a welding current from flowing through the central portion of each electron emitting surface while exerting uniform pressure onto whole surface of the cathode wafer.

According to still another aspect of the present invention, there is provided a method of manufacturing a cathode-ray tube which includes a method of manufacturing a cathode for a cathode-ray tube as set forth above.

### BRIEF DESCRIPTION OF THE DRAWINGS

These and other features, and advantages, of the present invention will be more clearly understood from the following detailed description taken in conjunction with the accompanying drawings, in which like reference numerals designate identical or corresponding parts throughout the figures, and in which:

FIG. 1 is a perspective view of a cathode pellet used in a cathode according an embodiment of the present invention;

FIG. 2 is a perspective view of a bottom plate used in a cathode according an embodiment of the present invention;

FIG. 3A is a side view illustrating a method of welding a cathode pellet and a bottom plate used in a cathode according to an embodiment of present invention;

FIG. 3B is a perspective view illustrating a welded cathode pellet assembly used in a cathode according an embodiment of the present invention;

FIG. 4A is a partially cross sectional side view of an example of an upper welding electrode used for welding a cathode pellet and a bottom plate according to the present invention;

FIG. 4B is a bottom view of the upper welding electrode shown in FIG. 4A;

FIG. 5A is a partially cross sectional side view of another example of an upper welding electrode used for welding a cathode pellet and a bottom plate according to the present invention;

FIG. 5B is a bottom view of the upper welding electrode shown in FIG. 5A;

FIG. 6 is a partially cross sectional side view showing a bottom plate used in a cathode according another embodiment of the present invention;

FIG. 7 is a partially cross sectional side view showing a cathode pellet assembly in which a cathode pellet and the bottom plate of FIG. 6 are welded;

FIG. 8 is a partially cross sectional side view illustrating a method of welding a cathode wafer and a bottom plate member for mass production of cathodes according to the present invention;

FIG. 9 is an illustration showing a method of blanking out a cathode wafer assembly to obtain cathode pellets with bottom plates according to the present invention;

FIG. 10 is a partially cut away perspective view showing an example of a cathode fabricated by using the cathode pellet assembly shown in FIG. 3B or FIG. 9 according to the present invention;

FIG. 11 is a partially cut away perspective view showing another example of a cathode fabricated by using the cathode pellet assembly shown in FIG. 7 according to the present invention; and

FIG. 12 is a partially cut away perspective view showing a conventional cathode.

### DESCRIPTION OF A PREFERRED EMBODIMENT

With reference to the drawings, a description will be made on embodiments of the present invention. In the following description, the n-th power of 10, i.e., 10ⁿ, is represented by 10 En, and the (−n)-th power of 10, i.e., 10⁻ⁿ, is represented by 10 E−n.

In an embodiment of the present invention, first, 100 grams of nickel powder having an average particle size of 5 μm, 6 grams of scandium oxide, and 60 grams of coprecipitated carbon salt of barium-strontium-calcium having an average particle size of 1-2 μm were uniformly mixed in a dry type mixer. The component mole ratio of the coprecipitated carbon salt is (barium:strontium:calcium)=(50:40:10). Among these, coprecipitated carbon salt of barium-strontium-calcium becomes an electron emission agent.

The above-mentioned mixed powder was press worked at room temperature and a cylindrical molded body was fabricated. At this stage, nickel powder was not yet sintered.

The molded body formed as above was enclosed within a glass capsule and air within the glass capsule was pumped out to obtain vacuum condition. The degree of vacuum in this condition was approximately 10 E−4 Pa. During the pumping operation, the molded body and the glass capsule were outgassed.

The molded body enclosed within the glass capsule was supplied to a hot isostatic pressure processing equipment, and sintered at a maximum pressure of 130 MPa, at a maximum temperature of 1100 degrees Celsius, and with a retaining time of 60 minutes at the maximum temperature. In this process, only nickel powder is sintered. Scandium oxide powder and coprecipitated carbon salt powder of barium-strontium-calcium are not sintered, but are held at holes of a mesh structure formed by nickel particles. The holes comprise open cores in which adjoining cores communicate with each other. Substances and gases within the holes can move between adjoining holes and can finally reach the surfaces of the sintered body. Since the molded body is sintered at high pressure as mentioned above, the coprecipitated carbon salt of barium-strontium-calcium is not decomposed to become oxide.

After cooling the glass capsule and the like, the capsule was taken out from the hot isostatic pressure processing equipment, and further the sintered body was taken out from the glass capsule.

The sintered body was first sliced by using a Green Carborundum (GC) 200# wheel to obtain cathode wafers each having a thickness of 0.5 mm. Then, the surface of the cathode wafer on the welding side was ground flat by using a Cubic Boron Nitride (CBN) 1000# grindstone and thereby the thickness of the cathode wafer became 0.15 mm. The electron emitting surface of the cathode wafer was then polished by using diamond slurry having a grain size of 1 μm, and thereby a nickel film which attached to the electron emitting surface when the sintered body was sliced was removed. As a result, the electron emitting surface became a mirror surface having a surface roughness of 1 μm or less. The thickness of the cathode wafer does not substantially change due to the polishing process of the electron emitting surface.

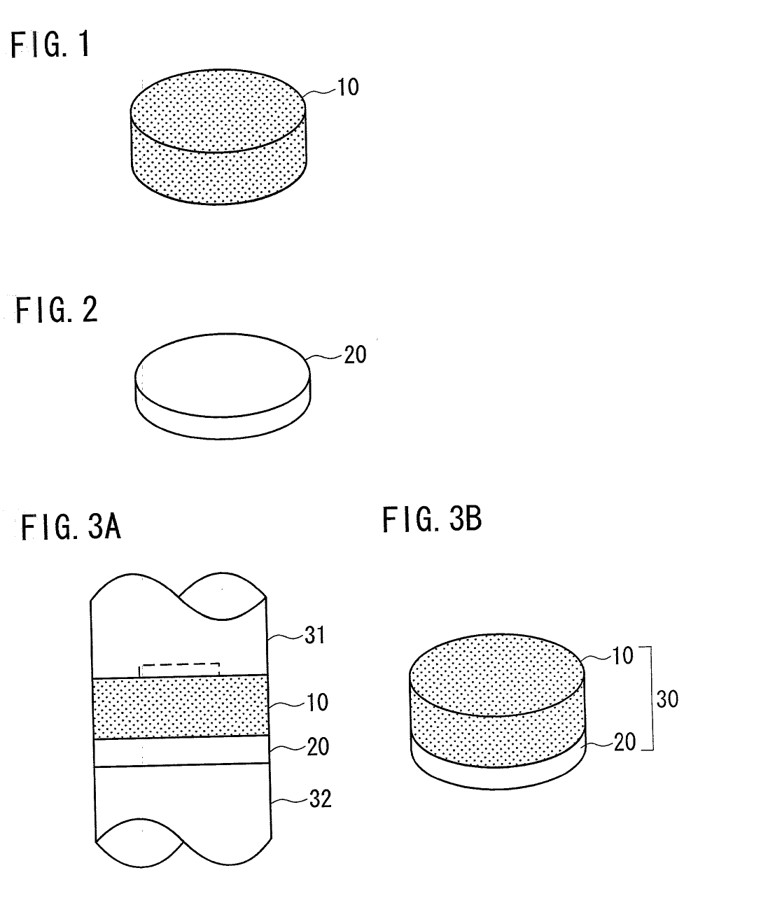

The cathode wafer was blanked out by using a press working machine which has a die and a punch made of ultra high strength steel, and thereby a cathode pellet 10 shown in FIG. 1 was obtained. The cathode pellet 10 has a cylindrical or column shape, and has a diameter of 1.2 mm and a thickness of 0.15 mm.

With respect to the bottom plate, a board of nickel-magnesium-tungsten alloy having a thickness of 50 μm was blanked or stamped out, and a disk shaped bottom plate 20 was obtained which is shown in FIG. 2 and which has a diameter of 1.2 mm and a thickness of 50 μm. Here, such disk shaped bottom plate is referred to as a first example of the bottom plate. The thickness of the bottom plate 20 is preferably 20-250 μm.

As shown in FIG. 3A, the cathode pellet 10 is piled on the bottom plate 20, and the piled cathode pellet 10 and the bottom plate 20 are pinched between an upper welding electrode 31 and a lower welding electrode 32. A large current is supplied between the upper welding electrode 31 and the lower welding electrode 32, and thereby the cathode pellet 10 and the bottom plate 20 are whole surface welded together by resistance welding. Each of the upper welding electrode 31 and the lower welding electrode 32 is made of tungsten, and has a diameter of 1.2 mm at the surface contacting the cathode pellet 10 and the bottom plate 20. In this way, a cathode pellet assembly 30, that is, the cathode pellet 10 with the bottom plate 20, was obtained as shown in FIG. 3B.

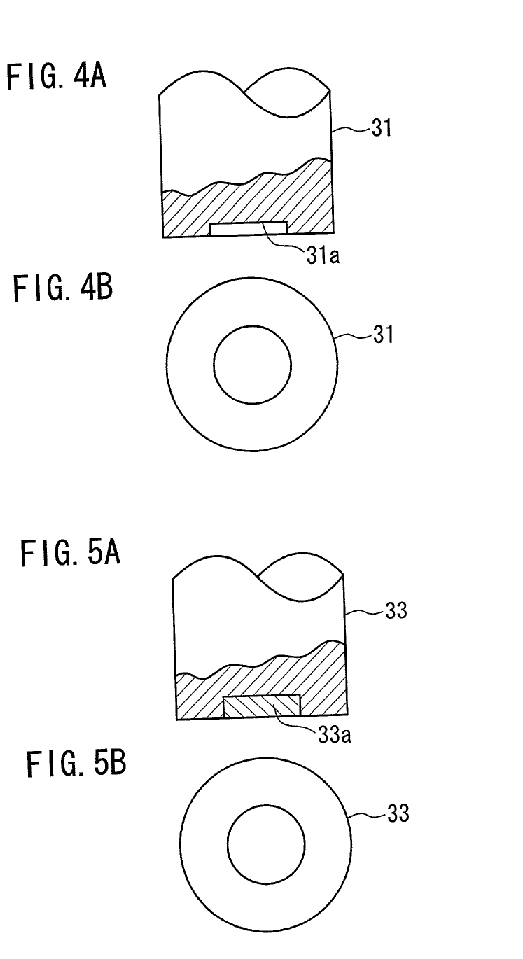

FIG. 4A is a partially cross sectional side view of the upper welding electrode 31. FIG. 4B is a bottom view of the upper welding electrode 31 of FIG. 4A. As shown in these drawings, there is provided a concave portion 31a at the central portion of the lower or bottom surface of the upper welding electrode 31. The concave portion 31a has, for example, a diameter of 0.5 mm and a depth of 0.1 mm. The concave portion 31a prevents the central portion of the lower surface of the upper welding electrode 31 from contacting with the cathode pellet 10. When welding the cathode pellet and the bottom plate, if a welding current flows through a portion of the cathode pellet from which electrons are actually emitted, that is, if a welding current flows through a central portion of the electron emitting surface which corresponds to a hole of the first grid electrode of a cathode-ray tube, there is a possibility that electron emission characteristics of the cathode pellet deteriorate. Therefore, a portion of the upper welding electrode corresponding to the central portion of the electron emitting surface of the cathode pellet is removed or caved such that the welding current does not flow through the central portion of the electron emitting surface of the cathode pellet.

FIG. 5A is a partially cross sectional side view of an upper welding electrode 33 as another example. FIG. 5B is a bottom view of the upper welding electrode 33 of FIG. 5A. As shown in these drawings, there is also provided a concave portion at the central portion of the lower or bottom surface of the upper welding electrode 33, and the concave portion is filled with an insulating member 33a. The concave portion and thus the insulating member 33a has, for example, a diameter of 0.5 mm and a depth of 0.5 mm. Therefore, the lower surface of the upper welding electrode 33 which contacts with the cathode pellet 10 has a flat surface without unevenness. The insulating member 33a is preferably made of aluminum oxide, aluminum nitride and the like. By using the upper welding electrode 33 having the above-mentioned structure, it is possible to prevent the welding current from flowing through the central portion of the electron emitting surface of the cathode pellet 10, while exerting a mechanical pressure on whole surface of the cathode pellet 10 by the upper welding electrode 33. Since the mechanical pressure is exerted on whole surface of the cathode pellet 10, it is possible to completely weld the cathode pellet 10 and the bottom plate 20 without causing any defect in welding therebetween.

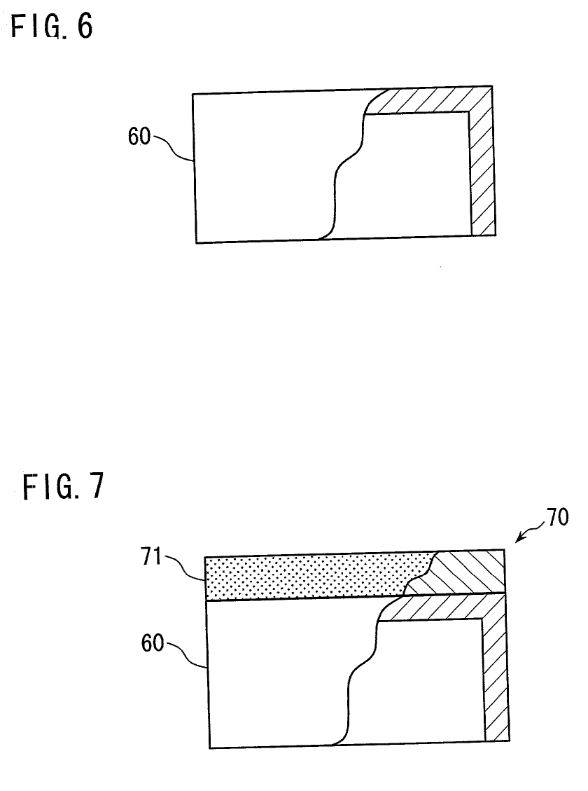

FIG. 6 is a partially cross sectional side view showing a second example of a bottom plate used in a cathode according to the present invention. The bottom plate 60 shown in FIG. 6 has a reversed cup shape. Also, FIG. 7 is a partially cross sectional side view showing a cathode pellet assembly 70 in which a disk shaped cathode pellet 71 is welded on the reversed cup shaped bottom plate 60. The cathode pellet 71 has a diameter of 1.2 mm, and a thickness of 0.15 mm. The reversed cup shaped bottom plate 60 is made of nickel-magnesium-tungsten alloy, and has an outer diameter of 1.2 mm, an inner depth of 0.5 mm, and a board thickness of 50 μm. The board thickness of the bottom plate 60 can be, for example, 20-250 μm. The cathode pellet 71 and the reversed cup shaped bottom plate 60 were resistance welded by putting them between an upper welding electrode and a lower welding electrode. The upper welding electrode has a diameter of 1.2 mm at a portion contacting the cathode pellet 71, and the lower welding electrode has a diameter of 1 mm at a portion inserted into the concave portion of the reversed cup shaped bottom plate 60. The shape and structure of the upper welding electrode used in this case may be the same as that shown in FIGS. 4A and 4B, or that shown in FIGS. 5A and 5B.

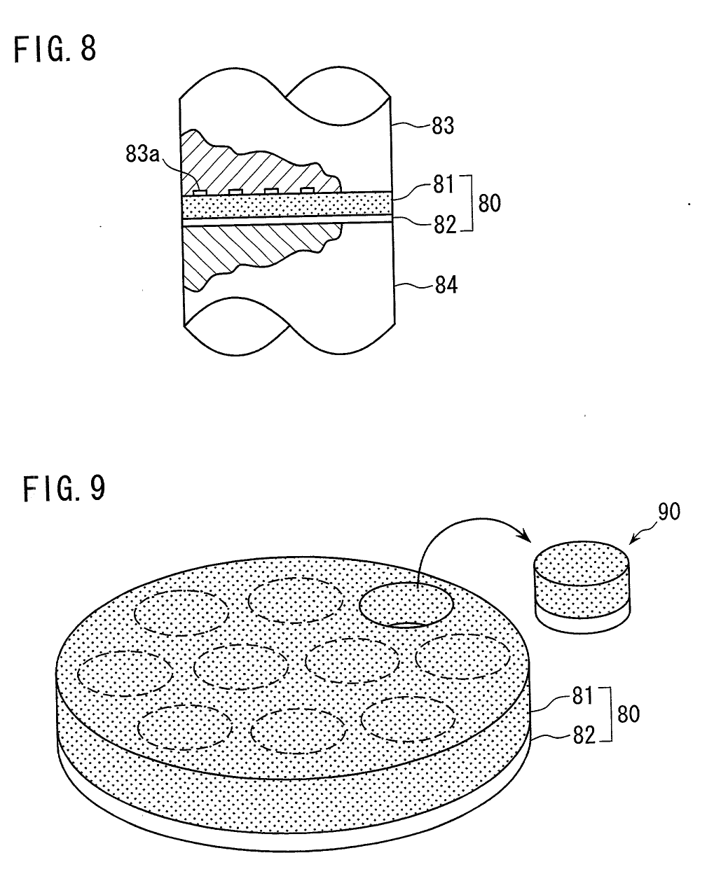

An explanation will now be made on a method of manufacturing a cathode pellet assembly which is suitable for mass production and in which a bottom plate member and a cathode wafer are welded before blanking out each cathode pellet assembly. As shown in FIG. 8, in this method, a cathode wafer 81 and a bottom plate member 82 are piled together, and pinched between an upper welding electrode 83 and a lower welding electrode 84. A large current is then supplied between the upper welding electrode 83 and the lower welding electrode 84 and thereby the cathode wafer 81 and the bottom plate member 82 are whole surface welded together. Thereby, a cathode wafer assembly 80 comprising the cathode wafer 81 with the bottom plate member 82 is obtained.

As shown in FIG. 9, a large number of cathode pellet assemblies 90 can be blanked out from the cathode wafer assembly 80. Therefore, as shown in FIG. 8, the upper welding electrode 83 has many concave portions 83a aligned with the blanking pitch of the cathode wafer assembly 80. The function of each of the concave portions 83a is to prevent a welding current from flowing through a portion of electron emitting surface of a cathode pellet. It is also preferable that each of the concave portions 83a is filled with an insulating material such that the lower surface of the upper welding electrode 83 which contacts with the cathode wafer 81 has a flat surface without unevenness.

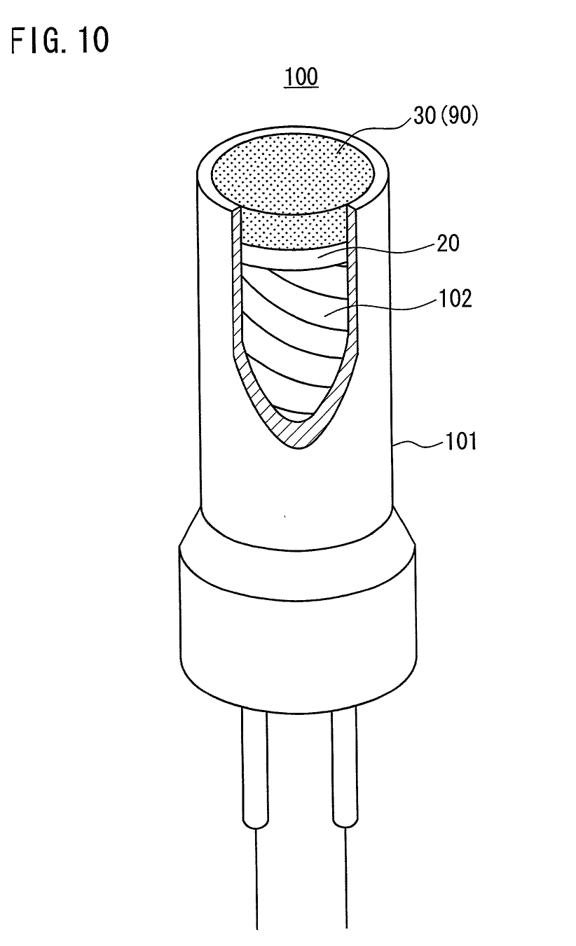

Next, as shown in FIG. 10, the cathode pellet assembly 30 (or 90) is inserted into the top portion of a sleeve 101, and the cathode pellet assembly 30 (or 90) and the peripheral portion of the sleeve 101 are welded by laser welding or resistance welding.

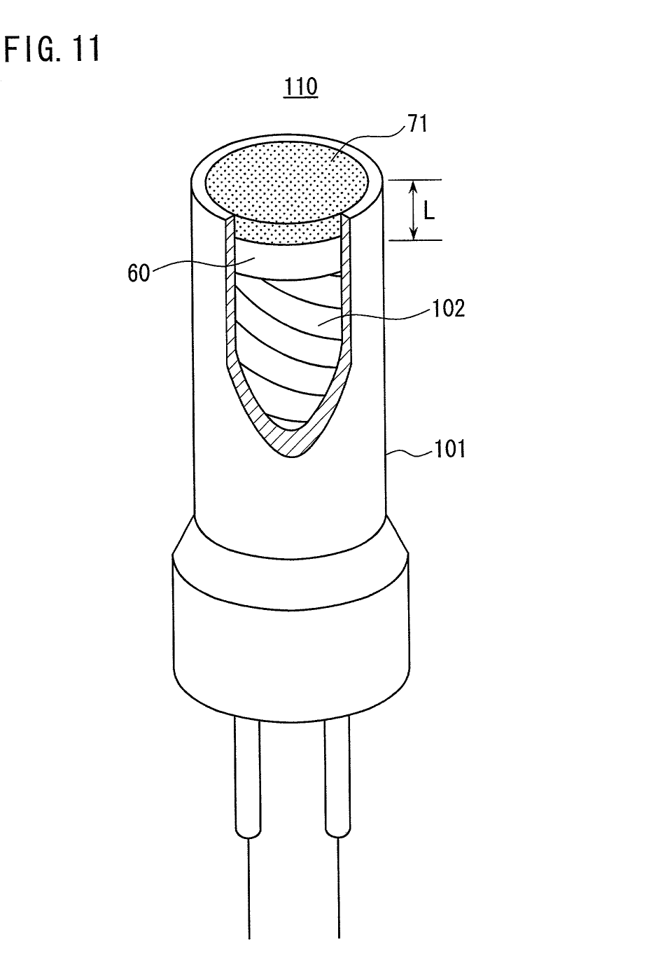

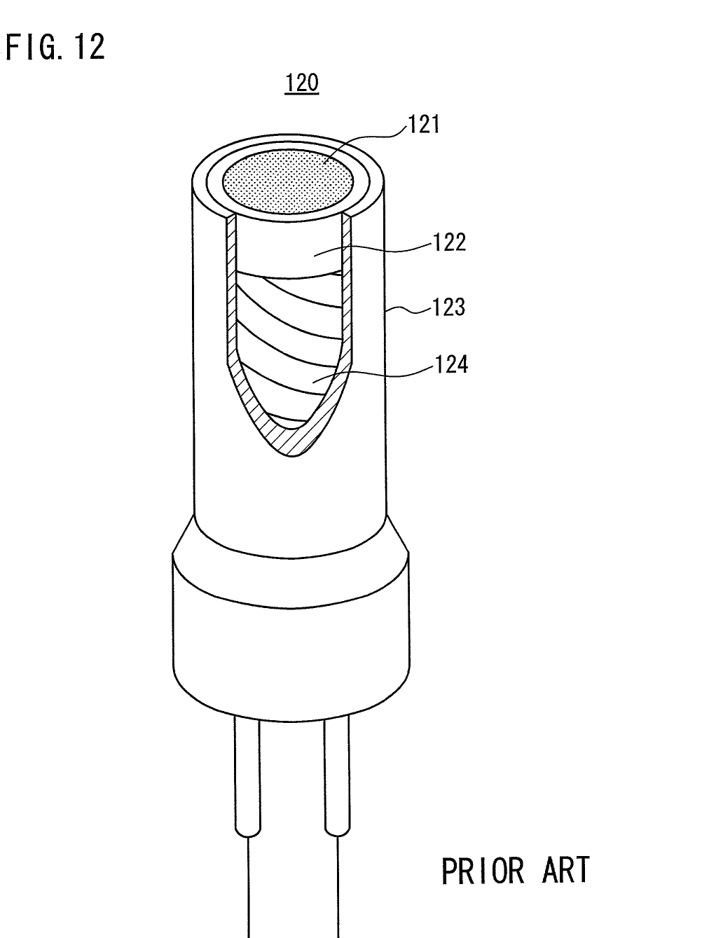

As shown in FIG. 11, in case the bottom plate comprises the reversed cup shaped member 60 as shown in FIGS. 6 and 7, the width of the portion which is usable for welding can be large (in this case, 0.7 mm). Therefore, it is possible to easily weld the sleeve 101 and the cathode pellet assembly 70 together.

Finally, as shown in FIGS. 10 or 11, a heater 102 is inserted into the sleeve 101 from the lower end portion thereof, and a cathode 100 or 110 according to the present invention is completed. In case the bottom plate is the reversed cup shaped bottom plate 60, the top portion of the heater 102 reaches the inner bottom surface of the reversed cup shaped bottom plate 60 although not shown in detail in FIG. 11.

The cathode according to the present invention can be mounted onto a cathode-ray tube such as a color cathode-ray tube in a manner similar to the conventional cathode. Also, the decomposition and activation of the cathode according to the present invention can be performed similarly to the conventional cathode. A large number of conventional cathodes and cathodes according to the present invention are mounted onto color cathode-ray tubes, and temperature variation of the cathode pellets was inspected. As a result, temperature variation or dispersion of the cathode pellets according to the present invention was much smaller than that of the conventional cathode pellets. The reason for this is considered as follows. That is, among the samples of the conventional cathodes, there are some samples in each of which a gap exists between the cathode pellet and the cup. On the other hand, in the cathodes according to the present invention, no sample exists which has a gap between the cathode pellet and the bottom plate.

In the cathode according to the present invention, a support member for a cathode pellet is changed from the conventional cup shaped member to a bottom plate which is a disk shaped member having the same diameter as that of the cathode pellet, or which is a reversed cup shaped member. The bottom plate is whole surface welded onto the bottom surface of the cathode pellet, and shields the heater from electron emission from the cathode pellet. Since the bottom plate can be the simple disk shaped member or can be the reversed cup shaped member in which a high precision of the depth is not required, it is possible to easily mass-produce such bottom plate. Also, it is possible to make the cathode pellet thinner than the conventional cathode pellet. Thereby, the heat capacity of the cathode pellet can be reduced, and a startup time of an image screen can be shortened. Also, it is possible to lower the heater temperature.

The cathode pellet and the bottom plate are put between upper and lower welding electrodes which have approximately the same diameter as that of the cathode pellet, and the cathode pellet and the bottom plate are resistance welded. Thereby, it becomes possible to whole surface weld the cathode pellet and the bottom plate without causing any gap therebetween. Since there is no gap between the cathode pellet and the bottom plate, the temperature of the cathode pellet does not disperse.

As a manufacturing method suitable for mass production, the present invention provides a method in which a cathode wafer and a bottom plate member are whole surface welded to prepare a cathode wafer with a bottom plate member, i.e., a cathode wafer assembly. The welded cathode wafer assembly is then blanked out to obtain cathode pellets with bottom plates, i.e., cathode pellet assemblies. This method is much more efficient than a method in which a cathode pellet and a bottom plate is aligned and welded one at a time.

By mounting the above-mentioned cathode according to the present invention onto a cathode-ray tube, it is possible to realize a cathode-ray tube, such as a color cathode-ray tube, which has a high brilliance and a long life and which has small dispersion of various characteristics.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative sense rather than a restrictive sense, and all such modifications are to be included within the scope of the present invention. Therefore, it is intended that this invention encompasses all of the variations and modifications as falling within the scope of the appended claims.

What is claimed is:

1. A cathode for a cathode-ray tube, said cathode comprising:
a cathode pellet formed from a sintered body which is obtained by sintering a mixture containing at least a nickel powder and a powder of electron emission agent by hot isostatic pressing; and
a cathode pellet support member on which said cathode pellet is attached to form a cathode pellet assembly, wherein said cathode pellet support member is a bottom plate which covers only a bottom surface of said cathode pellet.

2. A cathode for a cathode-ray tube as set forth in claim 1, wherein said bottom plate is made of a material selected from a group consisting of nickel-chromium alloy, nickel-magnesium-chromium alloy, nickel-magnesium-silicon-chromium alloy, nickel-magnesium-tungsten alloy, and nickel-magnesium-silicon-tungsten alloy.

3. A cathode for a cathode-ray tube as set forth in claim 1, wherein the thickness of said bottom plate is in a range from 20 to 250 μm.

4. A cathode for a cathode-ray tube as set forth in claim 1, wherein said cathode pellet has a column shape, and said bottom plate has a disk shape which has the same diameter as that of the bottom surface of said cathode pellet.

5. A cathode for a cathode-ray tube as set forth in claim 1, wherein said cathode pellet has a column shape, and said bottom plate has a reversed cup shape, wherein said cathode pellet is attached to the reversed outside bottom surface of said bottom plate, and said reversed cup shaped bottom plate has the same outer diameter as that of the bottom surface of said cathode pellet.

6. A cathode for a cathode-ray tube as set forth in claim 1, further comprising a sleeve, wherein said cathode pellet assembly is attached to the top portion of said sleeve by welding.

7. A cathode for a cathode-ray tube as set forth in claim 6, further comprising a heater which is inserted into said sleeve from the bottom portion thereof and which heats said cathode pellet via said bottom plate.

8. A cathode-ray tube which includes said cathode as set forth in claim 1.

9. A method of manufacturing a cathode for a cathode-ray tube comprising:
forming a sintered body by sintering a mixture containing at least a nickel powder and a powder of electron emission agent by hot isostatic pressing;
forming a cathode pellet from said sintered body;
welding a bottom plate onto the bottom surface of said cathode pellet to form a cathode pellet assembly, wherein said bottom plate covers only a bottom surface of said cathode pellet;
inserting said cathode pellet assembly into the top portion of a sleeve and welding said cathode pellet assembly to said sleeve at the top peripheral portion of said sleeve; and
inserting a heater into said sleeve from the bottom portion thereof.

10. A method of manufacturing a cathode for a cathode-ray tube as set forth in claim 9, wherein in said welding a bottom plate onto the bottom surface of said cathode pellet to form a cathode pellet assembly, said cathode pellet and said bottom plate are put between an upper welding electrode and a lower welding electrode which have approximately the same diameter as that of said cathode pellet, thereby resistance welding said cathode pellet and said bottom plate.

11. A method of manufacturing a cathode for a cathode-ray tube as set forth in claim 10, wherein said upper welding electrode has a concave portion at a portion of the bottom surface thereof corresponding to the central portion of the electron emitting surface of the cathode pellet which corresponds to a hole of the first grid electrode of a cathode-ray tube, thereby preventing the central portion of the lower surface of the upper welding electrode from contacting with the central portion of said electron emitting surface.

12. A method of manufacturing a cathode for a cathode-ray tube as set forth in claim 10, wherein said upper welding electrode has an insulating member buried in a portion of the bottom surface thereof corresponding to the central portion of the electron emitting surface of the cathode pellet which corresponds to a hole of the first grid electrode of a cathode-ray tube, thereby preventing a welding current from flowing through the central portion of said electron emitting surface while exerting uniform pressure onto whole surface of said cathode pellet.

13. A method of manufacturing a cathode-ray tube which includes a method of manufacturing a cathode for a cathode-ray tube as set forth in claim 9.

14. A method of manufacturing a cathode for a cathode-ray tube comprising:
forming a sintered body by sintering a mixture containing at least a nickel powder and a powder of electron emission agent by hot isostatic pressing;
forming a cathode wafer from said sintered body;
welding a bottom plate member onto the bottom surface of said cathode wafer to form a cathode wafer assembly;
working said cathode wafer assembly to form a cathode pellet with a bottom plate, that is, a cathode pellet assembly, wherein said bottom plate covers only a bottom surface of said cathode pellet;
inserting said cathode pellet assembly into the top portion of a sleeve and welding said cathode pellet assembly to said sleeve at the top peripheral portion of said sleeve; and
inserting a heater into said sleeve from the bottom portion thereof.

15. A method of manufacturing a cathode for a cathode-ray tube as set forth in claim 14, wherein in said welding a bottom plate member onto the bottom surface of said cathode wafer to form a cathode wafer assembly, said cathode wafer and said bottom plate member are put between an upper welding electrode and a lower welding electrode which have approximately the same diameter as that of said cathode wafer, thereby resistance welding said cathode wafer and said bottom plate member.

16. A method of manufacturing a cathode for a cathode-ray tube as set forth in claim 15, wherein said upper welding electrode has concave portions at portions of the bottom surface thereof each corresponding to the central portion of the electron emitting surface of said cathode pellet which corresponds to a hole of the first grid electrode of a cathode-ray tube, thereby preventing the lower surface of the upper welding electrode from contacting with the central portion of each electron emitting surface.

17. A method of manufacturing a cathode for a cathode-ray tube as set forth in claim 15, wherein said upper welding electrode has insulating members buried in portions of the bottom surface thereof each corresponding to the central portion of the electron emitting surface of said cathode pellet which corresponds to a hole of the first grid electrode of a cathode-ray tube, thereby preventing a welding current from flowing through the central portion of each electron emitting surface while exerting uniform pressure onto whole surface of said cathode wafer.

18. A method of manufacturing a cathode-ray tube which includes a method of manufacturing a cathode for a cathode-ray tube as set forth in claim 14.
